(19) United States
(12) Patent Application Publication
(10) Pub. No.: US 2006/0221193 A1
(43) Pub. Date: Oct. 5, 2006

(54) Visualizer and signal transmission method using low voltage differential signal technology

(75) Inventor: Sean Zhang, Hsinchu City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: LUMENS DIGITAL OPTICS INC, Jhubei City (TW)

(21) Appl. No.: 11/351,580

(22) Filed: Feb. 10, 2006

(30) Foreign Application Priority Data
Mar. 30, 2005 (TW) 094110154

(51) Int. Cl. H04N 5/225

(52) U.S. Cl. 348/207.99

(57) ABSTRACT

A visualizer is provided. The visualizer includes a camera lens capturing an image of an object; an image sensing element generating a signal in response to the image of the object; an analog-to-digital converter converting the signal into a digital signal; a transmitting terminal electrically connected to the analog-to-digital converter and transmitting the digital signal through the low voltage differential signal technology; and a receiving terminal receiving the digital signal.

### FIELD OF THE INVENTION

The present invention relates to a visualizer and a signal transmission method, and more particularly to a visualizer and a signal transmission method using the low voltage differential signal technology.

### BACKGROUND OF THE INVENTION

The visualizer is a multi-function device capable of converting an image into digital data via a simple connection. For example, the image could be a picture, a positive or negative film, a slide, or even a three-dimensional object.

FIG. 1 is a schematic diagram showing the structure of a conventional visualizer using the analog transmission. The visualizer includes a camera lens 11, a charge-coupled image sensing element 12, an analog-to-digital converter (ADC) 13 and an image processing unit 14. Usually, the camera lens 11 and the charge-coupled image sensing element 12 are put closely. The ADC 13 and the image processing unit 14 are put closely. The image processing unit 14 is away from the charge-coupled image sensing element 12. The camera lens 11 is used for capturing the image of an object, and the charge-coupled image sensing element 12 is used for generating a signal in response to the image of the object. Then, the signal is transmitted to the analog-to-digital converter 13 in an analog way for being converted into a digital signal. Next, the digital signal is transmitted to the image processing unit 14 for image processing.

Based on the above, it is known that in the conventional visualizer, the signal is transmitted in an analog way for a relatively long distance. This results in a signal quality loss due to long cable with analog transmission.

The present invention provides a novel visualizer and signal transmission method using the low voltage differential signal technology to keep the image quality when the signal is transmitted. The analog signal is digitized and transformed into a low voltage differential signal format before transmission. There is a low voltage differential signal receiver close to the image processing unit, so the signal transmission is proceeded in the low voltage differential signal format through the long cable.

### SUMMARY OF THE INVENTION

In accordance with one aspect of the present invention, a visualizer using the low voltage differential signal technology is provided to keep the image quality when the signal is transmitted.

In accordance with another aspect of the present invention, a visualizer is provided. The visualizer includes a camera lens capturing an image of an object; an image sensing element generating a signal in response to the image of the object; an analog-to-digital converter converting the signal into a digital signal; a transmitting terminal electrically connected to the analog-to-digital converter and transmitting the digital signal through the low voltage differential signal technology; and a receiving terminal receiving the digital signal.

Preferably, the image sensing element is a charge-coupled image sensing element. Preferably, the transmitting terminal is a low voltage differential signal transmitting terminal.

Preferably, the receiving terminal is a low voltage differential signal receiving terminal.

Preferably, the visualizer further includes an image processing unit electrically connected to the low voltage differential signal receiving terminal and processing the digital signal.

In accordance with a further aspect of the present invention, a visualizer is provided. The visualizer includes a camera lens capturing an image of an object; an image sensing element generating a signal in response to the image of the object; a transmitting terminal transmitting the digital signal through the low voltage differential signal technology; and a receiving terminal receiving the signal.

Preferably, the image sensing element is a complementary metal-oxide semiconductor image sensing element.

Preferably, the transmitting terminal is a low voltage differential signal transmitting terminal.

Preferably, the receiving terminal is a low voltage differential signal receiving terminal.

Preferably, the visualizer further includes an image processing unit electrically connected to the low voltage differential signal receiving terminal and processing the signal. The image processing unit can be, for example, a chip or a microprocessor that transforms the raw data of the image sensing element into a displayable RGB or YUV format.

In accordance with further another aspect of the present invention, a signal transmission method for use in a visualizer is provided. The method includes steps of capturing an image of an object and converting it into a signal; converting the signal into a digital signal; and transmitting the digital signal through a low voltage differential signal technology.

Preferably, the image of the object is captured by a camera lens and converted into the signal by an image sensing element.

Preferably, the image sensing element is a charge-coupled image sensing element.

Preferably, the signal is converted into the digital signal by an analog-to-digital converter.

Preferably, the method further includes a step of processing the digital signal.

In accordance with further another aspect of the present invention, a signal transmission method for use in a visualizer is provided. The method includes steps of capturing an image of an object and converting it into a digital signal; and transmitting the digital signal through a low voltage differential signal technology.

Preferably, the image of the object is captured by a camera lens and converted into the digital signal by an image sensing element.

Preferably, the image sensing element is a complementary metal-oxide semiconductor image sensing element.

Preferably, the method further includes a step of processing the digital signal.

The above objects and advantages of the present invention will become more readily apparently to those ordinarily skilled in the art after reviewing the following detailed descriptions and accompanying drawings, in which:

### BRIEF DESCRIPTION OF THE DRAWINGS

FIG. 1 is a schematic diagram showing the structure of a conventional visualizer using the analog transmission;

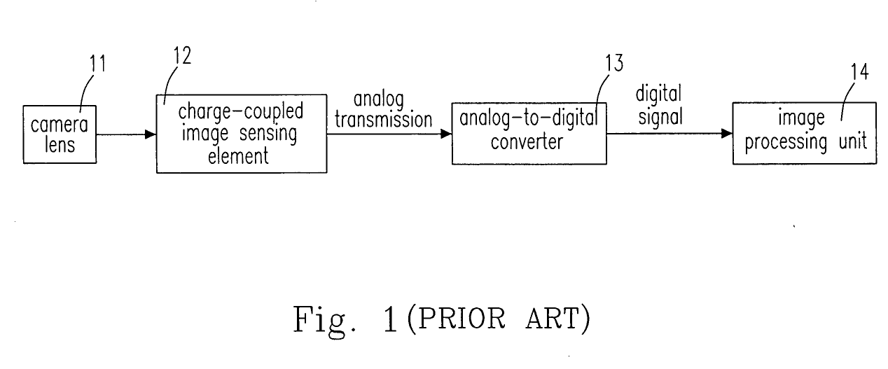

FIG. 2 is a schematic diagram showing the structure of a visualizer using the low voltage differential signal technology according to a preferred embodiment of the present invention; and

FIG. 3 is a schematic diagram showing the structure of a visualizer using the low voltage differential signal technology according to another preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

To reduce the signal loss when transmitted, the low voltage differential signal (LVDS) technology is used in the present invention for the signal transmission. The LVDS technology is a kind of special signal transmission technology, which transmits an electrical signal via a pair of wires wherein there is a voltage difference between two wires of each pair of wires. The value of the signal being transmitted is determined based on the voltage difference. Although the voltage of each wire may fluctuate in the transmission process, the voltage difference between two wires of each pair of wires is relatively stable, so the signal error hardly occurs. Hence, the LVDS technology is free of external interference. Additionally, the LVDS technology only needs a very low voltage (about 350 mV) for operation, and therefore it has the advantages of low power consumption and high stability.

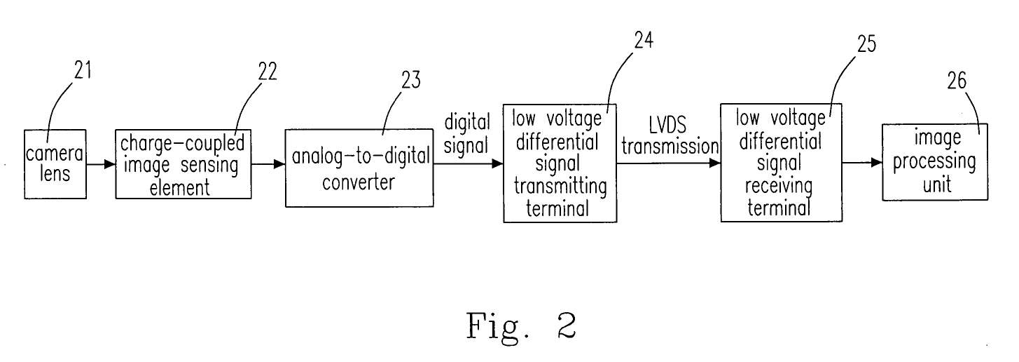

Please refer to FIG. 2, which is a schematic diagram showing the structure of a visualizer using the low voltage differential signal technology according to a preferred embodiment of the present invention. The visualizer includes a camera lens 21, a charge-coupled image sensing element 22, an analog-to-digital converter 23, a low voltage differential signal transmitting terminal 24, a low voltage differential signal receiving terminal 25 and an image processing unit 26. The image processing unit 26 can be, for example, a chip or a microprocessor that transforms the raw data of the charge-coupled image sensing element 22 into a displayable RGB or YUV format. The camera lens 21 is used for capturing the image of an object, and the charge-coupled image sensing element 22 is used for generating a signal in response to the image of the object. The signal is converted into a digital signal by the analog-to-digital converter 23, and then the digital signal is transmitted to the low voltage differential signal transmitting terminal 24. Subsequently, the low voltage differential signal transmitting terminal 24 transmits the digital signal to the low voltage differential signal receiving terminal 25 through the LVDS technology, and then the digital signal is processed by the image processing unit 26.

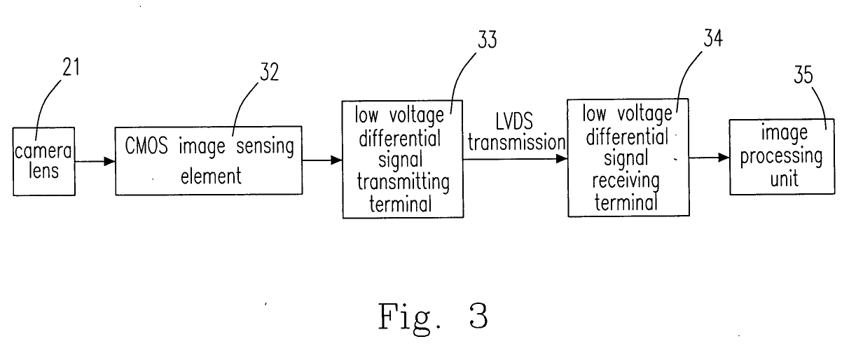

The charge-coupled image sensing element is used as an example in the above embodiment. However, other image sensing elements can be used in the present invention, such as a complementary metal-oxide semiconductor (CMOS) image sensing element as shown in FIG. 3. The visualizer of FIG. 3 includes a camera lens 31, a CMOS image sensing element 32, a low voltage differential signal transmitting terminal 33, a low voltage differential signal receiving terminal 34 and an image processing unit 35. The camera lens 31 is used for capturing the image of an object, and the CMOS image sensing element 32 is used for generating a signal in response to the image of the object. Since the signal itself is a digital signal, it could be transmitted directly to the low voltage differential signal transmitting terminal 33 without conversion by the analog-to-digital converter. The low voltage differential signal transmitting terminal 33 transmits the signal to the low voltage differential signal receiving terminal 34 through the LVDS technology, and then the signal is processed by the image processing unit 35.

The present invention utilizes the LVDS technology to transmit the signal, through which the image quality is kept. While the invention has been described in terms of preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A visualizer, comprising:
a camera lens capturing an image of an object;
an image sensing element generating a signal in response to the image of the object;
an analog-to-digital converter converting the signal into a digital signal;
a transmitting terminal electrically connected to the analog-to-digital converter and transmitting the digital signal through the low voltage differential signal technology; and
a receiving terminal receiving the digital signal.

2. The visualizer as claimed in claim 1, wherein the image sensing element is a charge-coupled image sensing element.

3. The visualizer as claimed in claim 1, wherein the transmitting terminal is a low voltage differential signal transmitting terminal.

4. The visualizer as claimed in claim 1, wherein the receiving terminal is a low voltage differential signal receiving terminal.

5. The visualizer as claimed in claim 4, further comprising an image processing unit electrically connected to the low voltage differential signal receiving terminal and processing the digital signal.

6. A visualizer, comprising:
a camera lens capturing an image of an object;
an image sensing element generating a signal in response to the image of the object;
a transmitting terminal transmitting the digital signal through the low voltage differential signal technology; and
a receiving terminal receiving the signal.

7. The visualizer as claimed in claim 6, wherein the image sensing element is a complementary metal-oxide semiconductor (CMOS) image sensing element.

8. The visualizer as claimed in claim 6, wherein the transmitting terminal is a low voltage differential signal transmitting terminal.

9. The visualizer as claimed in claim 6, wherein the receiving terminal is a low voltage differential signal receiving terminal.

10. The visualizer as claimed in claim 6, further comprising an image processing unit electrically connected to the low voltage differential signal receiving terminal and processing the signal.

11. A signal transmission method for use in a visualizer, comprising steps of:
capturing an image of an object and converting it into a signal;
converting the signal into a digital signal; and
transmitting the digital signal through a low voltage differential signal technology.

12. The method as claimed in claim 11, wherein the image of the object is captured by a camera lens and converted into the signal by an image sensing element.

13. The method as claimed in claim 12, wherein the image sensing element is a charge-coupled image sensing element.

14. The method as claimed in claim 11, wherein the signal is converted into the digital signal by an analog-to-digital converter.

15. The method as claimed in claim 11, further comprising a step of processing the digital signal.

16. A signal transmission method for use in a visualizer, comprising steps of:
capturing an image of an object and converting it into a digital signal; and
transmitting the digital signal through a low voltage differential signal technology.

17. The method as claimed in claim 16, wherein the image of the object is captured by a camera lens and converted into the digital signal by an image sensing element.

18. The method as claimed in claim 17, wherein the image sensing element is a complementary metal-oxide semiconductor image sensing element.

19. The method as claimed in claim 16, further comprising a step of processing the digital signal.
